(19) United States
(12) Patent Application Publication
(10) Pub. No.: US 2005/0267966 A1
(43) Pub. Date: Dec. 1, 2005

(54) Methods, systems and computer program products for auditing network device configurations

(76) Inventor: Christopher Boston, Acworth, GA (US)

Correspondence Address: CANTOR COLBURN LLP, 55 GRIFFIN ROAD SOUTH, BLOOMFIELD, CT, 06002, US

(21) Appl. No.: 10/847,281

(22) Filed: May 17, 2004

(51) Int. Cl. G06F 15/173

(52) U.S. Cl. 709/224

(57) ABSTRACT

A method for auditing network device configurations. The method includes gathering configuration data from at least one network device. The configuration data for the network device is compared to a corresponding template. Exception data is generated in response to the comparing. A report is generated in response to receiving a reporting request from a user, where input to the report includes the exception data.

### FIELD OF THE INVENTION

The present disclosure relates generally to computer networks and in particular, to methods, systems and computer program products for auditing network device configurations.

### BACKGROUND OF THE INVENTION

A computer network is a geographically distributed collection of interconnected communication links for transporting data between nodes, such as computers. By definition, a network is a group of computers and associated devices that are connected by communications facilities or links. Network connections can be of a permanent nature, such as cables, or can be of a temporary nature, such as connections made through telephones or other communication links. A plurality of computer networks may be further interconnected by intermediate nodes, or routers, to extend the effective “size” of the networks. A router is a computer system that stores and forwards data packets from one local area network (LAN) or wide area network (WAN) to another. Routers see the network as network addresses and all the possible paths between them. They read the network address in a transmitted message and can make a decision on how to send it based on the most expedient route (traffic load, line costs, speed, bad lines, etc.). Routers typically communicate by exchanging discrete “packets” of data according to predefined protocols. In this context, a protocol comprises a set of rules defining how the nodes interact with each other

Service providers that support a large number of service devices (e.g., routers) typically specify some number of standard configurations for each type of service device for ease in maintenance. Without standardized configurations, troubleshooting may become very complex causing error correction to require additional time. When standard service device configurations are implemented, a network engineer may be able to more quickly debug network errors because the configuration of each router, or network device, is known to include one of a defined set of configuration values. In a large scale Internet protocol (IP) based network, changes to network devices are not always as controlled as they could be and configurations of network devices may not conform to the standard configurations. Configurations of individual network devices (e.g. routers) can be set to non-standard configurations for several reasons such as: problem determination, new installation, bad information, and incorrect initial configuration.

Typically, a manual process is performed by network engineers to confirm that all routers in a particular network meet minimum configuration standards and then to correct those that don't conform to the configuration standards. This can be a very time consuming process for corporations (e.g., service providers) that have thousands of network devices.

### SUMMARY OF THE INVENTION

Embodiments of the present invention include a method for auditing network device configurations. The method includes gathering configuration data from at least one network device. The configuration data for each network device is compared to a corresponding template. Exception data is generated in response to the comparing. A report is generated in response to receiving a reporting request from a user, where input to the report includes the exception data.

Further embodiments of the present invention include a system for auditing network device configurations. The system includes a host system and at least one network device. The host system includes instructions to implement a method including gathering configuration data from the at least one network device. The configuration data for each network device is compared to a corresponding template. Exception data is generated in response to the comparing. A report is generated in response to receiving a reporting request from a user, where input to the report includes the exception data.

Still further embodiments of the present invention include a computer program product for auditing network device configurations. The computer program product includes a storage medium readable by a processing circuit and stores instructions for execution by the processing circuit for facilitating a method that includes gathering configuration data from at least one network device. The configuration data for each network device is compared to a corresponding template. Exception data is generated in response to the comparing. A report is generated in response to receiving a reporting request from a user, where input to the report includes the exception data.

Other systems, methods and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Referring to the exemplary drawings wherein like elements are numbered alike in the several FIGURES:

FIG. 1 is a block diagram of a system for auditing network device configurations in accordance with exemplary embodiments of the present invention;

FIG. 2 is a block diagram of an exemplary process for generating exception data in accordance with exemplary embodiments of the present invention;

FIG. 3 depicts a sample template database table in accordance with exemplary embodiments of the present invention;

FIG. 4 depicts a sample exception database table in accordance with exemplary embodiments of the present invention;

FIG. 5 is a block diagram of an exemplary process for generating exception reports in accordance with exemplary embodiments of the present invention; and

FIG. 6 is a sample user interface screen for generating exception reports in accordance with exemplary embodiments of the present invention.

### DETAILED DESCRIPTION OF THE INVENTION

Exemplary embodiments of the present invention replace the manual method of confirming that all network devices (e.g., routers) in a network meet minimum configuration standards. Network engineers are provided with the ability to electronically view device configuration parameters that deviate from the standard configurations. This may include both incorrect and missing parameters. This ability to view incorrect and missing parameters is provided by computer instructions, referred to collectively herein as auditing software. The auditing software executes periodically (e.g., every twenty-four hours) and checks the configurations of network devices for any deviations from the standard configurations. The auditing software includes a backend data gathering engine that pulls the configuration data from the network devices, parses the data and then stores the data in a gathered data database for evaluation. The gathered data database entries are compared to templates containing the standard configurations and inconsistencies between the gathered data and template data are stored in an exception database for access and reporting. A web interface is provided that allows for canned reports and user controlled reports to be generated based on the exception data. Exemplary embodiments of the present invention reduce the time required for verifying router configurations when compared to a manual process. In addition, trends can be spotted and analysis performed based on the exception data.

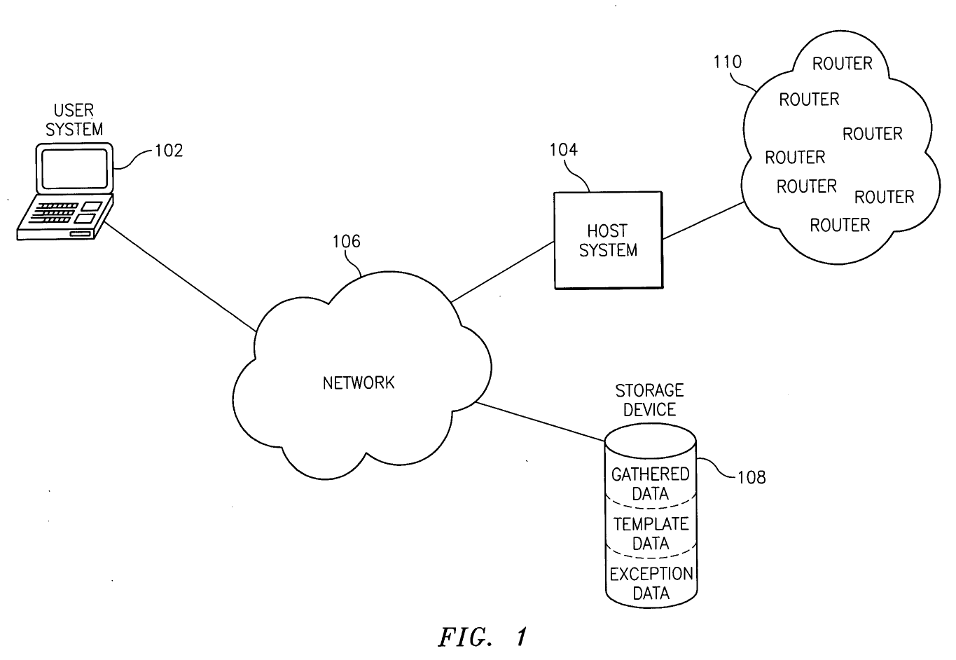

FIG. 1 is a block diagram of a system for auditing network device configurations in accordance with exemplary embodiments of the present invention. FIG. 1 includes a host system 104 for executing the auditing software. The system in FIG. 1 also includes one or more user systems 102 through which users located at one or more geographic locations may contact the host system 104 to initiate exception reporting functions. In exemplary embodiments of the present invention, the host system 104 executes the auditing software and the user system 102 is coupled to the host system 104 via a network 106. In alternate exemplary embodiments, the user system 102 is directly connected to the host system 104. Each user system 102 may be implemented using a general-purpose computer executing a computer program for carrying out the processes described herein. The user system 102 may be a personal computer (e.g., a lap top, a personal digital assistant) or a host attached terminal. If the user system 102 is a personal computer, the processing described herein may be shared by the user system 102 and the host system 104.

The network 106 may be any type of known network including, but not limited to, a wide area network (WAN), a local area network (LAN), a global network (e.g. Internet), a virtual private network (VPN), and an intranet. The network 106 may be implemented using a wireless network or any kind of physical network implementation known in the art. A user system 102 may be coupled to the host system through multiple networks (e.g., intranet, Ethernet LAN, and LAN) so that not all user systems 102 are coupled to the host system 104 through the same network. One or more of the user systems 102 and the host system 104 may be connected to the network 106 in a wireless fashion.

The storage device 108 depicted in FIG. 1 may be implemented using a variety of devices for storing electronic information. It is understood that the storage device 108 may be implemented using memory contained in the host system 104 or it may be a separate physical device. The storage device 108 is logically addressable as a consolidated data source across a distributed environment that includes a network 106. The physical data may be located in a variety of geographic locations depending on application and access requirements. Information stored in the storage device 108 may be retrieved and manipulated via the host system 104 and/or via the user system 102 if portions of the audit software are executed on the user system 102. The storage device 108 includes application data utilized by the audit software such as gathered data, template data and exception data. In exemplary embodiments of the present invention, the host system 104 operates as a database server and coordinates access to application data including data stored on storage device 108. Access to data contained in storage device 108 may be restricted based on user characteristics.

The host system 104 depicted in FIG. 1 may be implemented using one or more servers operating in response to a computer program stored in a storage medium accessible by the server. The host system 104 operates as a network server (e.g., a web server) to communicate with the user system 102. The host system 104 handles sending and receiving information to and from the user system 102 and can perform associated tasks. The host system 104 may reside behind a firewall to prevent unauthorized access to the host system 104 and enforce any limitations on authorized access. A firewall may be implemented using conventional hardware and/or software as is known in the art.

The host system 104 may also operate as an application server. The host system 104 executes one or more computer programs to implement the audit software. The processing of the audit software may be shared by the user system 102 and the host system 104 by providing an application (e.g., a java applet) to the user system 102. As previously described, it is understood that separate servers may be utilized to implement the network server functions and the application server functions. Alternatively, the network server, the firewall, and the application server may be implemented by a single server executing computer programs to perform the requisite functions.

The host system 104 depicted in FIG. 1 is in communication with a network 110 that includes a plurality of routers that are being audited to verify that they conform to the standard configurations. Exception data is produced for routers that do not conform to the standard configurations. Network 110 and network 106 may be the same physical and/or logical network or they may be different networks. In alternate exemplary embodiments, the configuration data is gathered and entered into the storage device 108 by a computer system other than the host system 104.

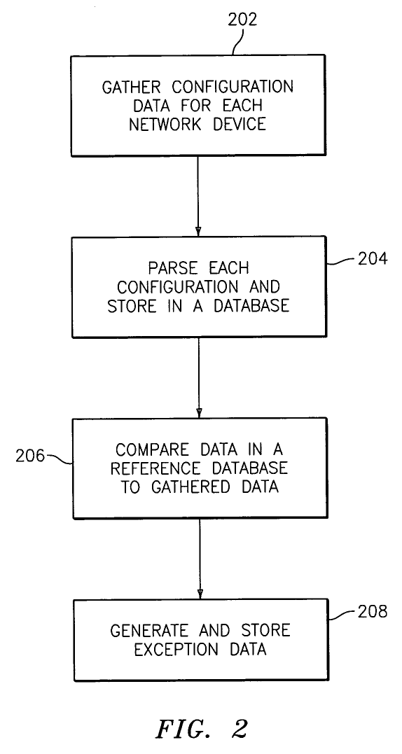

FIG. 2 is a block diagram of an exemplary process for generating exception data in accordance with exemplary embodiments of the present invention. At 202, configuration data for each network device in the network 110 is collected. Configuration data may be gathered in any manner known in the art. For example, the configuration data may be gathered by accessing a directory of network devices, where the directory corresponds to the network 110 being audited for network device conformance to standard configurations. Each device listed in the directory is then accessed and configuration data pertaining to the device is gathered by querying the device for the configuration information. Another alternative for gathering configuration data includes having the network devices send configuration data without being queried. The sending of configuration data may occur on a periodic basis. In addition the sending configuration data for a particular device may occur in response to the configuration data for the particular device being updated. This gathered data, containing configurations for the network devices in the network 110 is stored, permanently or temporarily, in the storage device 108.

At 204, the gathered data is parsed and stored in the storage device 108. Parsing includes adding the network device unique identifier, reflected below as “host”, to the configuration data. Following is an example of a portion of gathered data for a particular device that may be output from 204:

host ssr01asm

tacacs-server host 172.16.0.132

tacacs-server host 209.215.34.12

tacacs-server host 172.16.0.133

tacacs-server host 209.215.34.11

tacacs-server timeout 10

tacacs-server key test

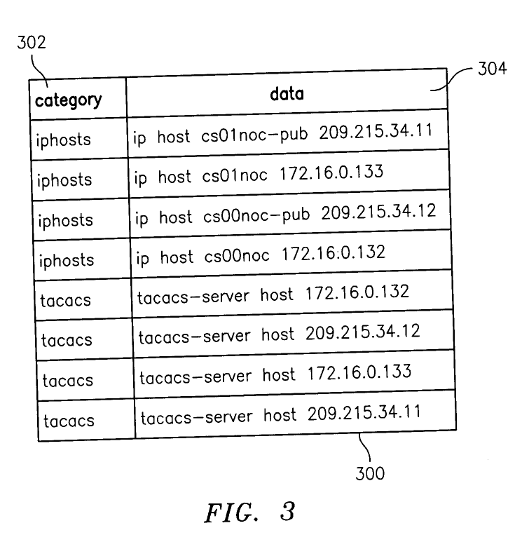

Once the data is parsed at 204, 206 is performed and the template data is compared to the gathered data. FIG. 3 depicts a sample template database table 300 in accordance with exemplary embodiments of the present invention. The template database table 300 is stored and/or accessed via the storage device 108. The template database table 300 depicted in FIG. 3 includes valid IP addresses and terminal access concentrator access control server (TACACS) addresses. The template database table 300 includes a category column 302 and a data column 304. The category column 302 contains the type of host, in this case IP or TACACS. The data column 304 contains valid IP addresses associated with the types of hosts listed in the category column 302. Other templates are also utilized by exemplary embodiments of the present invention to determine if a configuration is compliant with a standard configuration. Other templates may include a privilege template, a bandwidth template, a media type template and a port status template. Templates may be set up for any configuration parameters utilized by a network device. Data within the templates may be global and apply to all network devices or they may correspond to particular network device types. In alternate exemplary embodiments, a subset of the configuration parameters are subject to configuration standards and only the subset of configuration parameters correspond to templates.

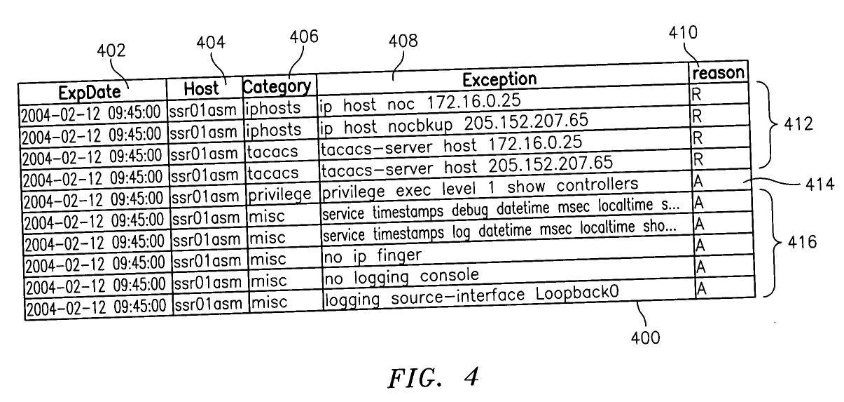

If the router does not contain the correct values, as determined at 206, then an entry for each parameter that is incorrect is stored in an exception table at 208. FIG. 4 depicts a sample exception database table 400 in accordance with exemplary embodiments of the present invention. The exception database table 400 includes an exception date column 402, an exception network device identifier column 404, a category column 406, an exception detail column 408 and a reason column 410. The exception date column 402 contains the date that the exception was detected. The exception network device identifier column 404 contains the name of the network device that corresponds to the exception. The category column 406 includes an abbreviated description of the type of exception and the exception detail column 408 describes the exception. The reason column 410 indicates a recommended course of action to the user. The value “R” indicates that the parameter should be removed, “A” that the parameter should be added, and “I” that the parameter is incorrect.

The first four lines 412 in the exception database table 400 depicted in FIG. 4 include a verification that valid IPhost and TACACS addresses have been specified by the configuration. The fifth line 414 in the exception database table 400 includes an exception having to do with privilege. The reason column 410 indicates that the configuration should be modified to include a parameter for restricting the show controllers command to “level 1.” The last five lines 416 in the exception database table 400 include exceptions in the miscellaneous category. The reason column 410 indicates that all of these parameters should be added to the configuration. A parameter to time stamp the log and debug output with the current date and time is recommended along with parameters to: disable the IP finger, suppress the printing of syslog messages to a terminal console, enable logging from a specific source interface. As described previously, these exceptions and reasons were generated by comparing the gathered data to the template data. The categories depicted in FIG. 4 are exemplary in nature and other categories of exceptions may be included in the exception database table 400 based on the contents of standard configurations in a particular implementation.

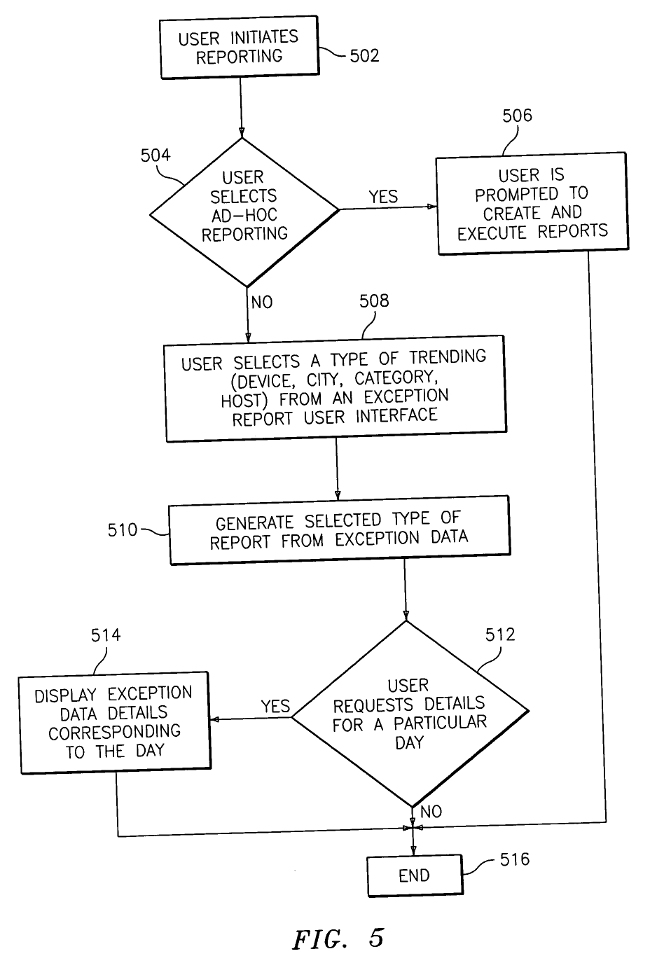

FIG. 5 is a block diagram of an exemplary process for generating exception reports from data in the exception database table 400 in accordance with exemplary embodiments of the present invention. At 502, a user, at a user system 102 initiates the reporting function. At 504, it is determined if the user selected ad-hoc reporting. If the user did select ad-hoc reporting then 506 is performed and the user is prompted to create and execute ad-hoc reports against the data in the exception database table. Any ad-hoc reporting tool known in the art may be utilized to provide this function. When the user is done creating ad-hoc reports processing ends at 516.

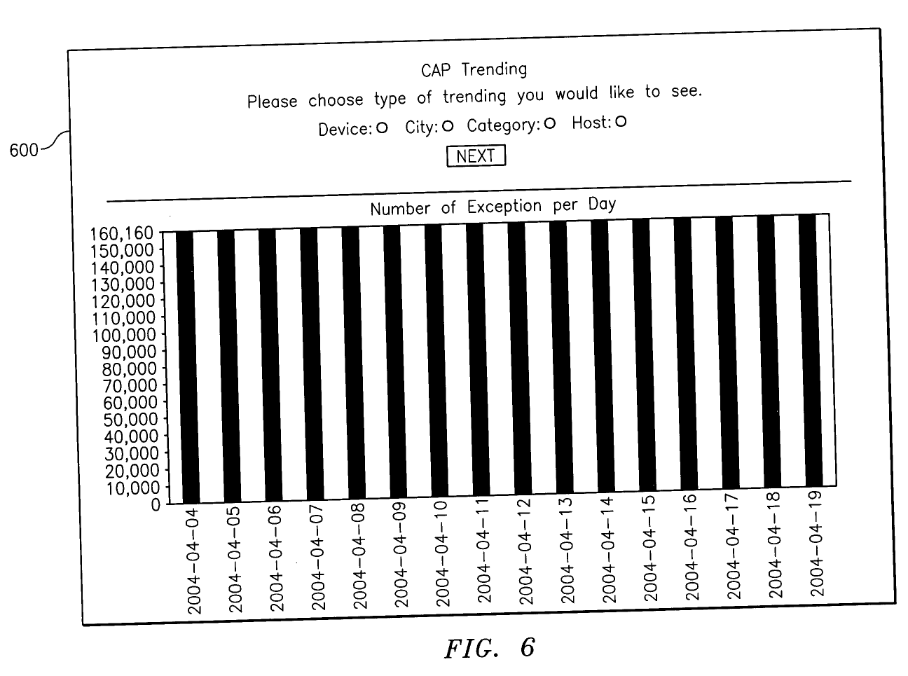

If the user did not select ad-hoc reporting at 504, then, at 508, a user interface such as that shown in FIG. 6 is presented to the user. FIG. 6 is a sample user interface 600 for generating exception reports in accordance with exemplary embodiments of the present invention. The user selects a type of trending from the user interface 600. This may include trending by device, city, category or host. At 510, a report responsive to the type of trending requested by the user. The report is generated from the exception data (e.g., the exception database table 400).

In exemplary embodiments of the present invention, if the user selects trending by device at 508, then reports are pulled based on a particular device type (e.g., BMF access router, BMF extension router). The device type may be selected from a pull down menu of all device types. Once the device type is selected, the resulting report is presented to the user in any form known in the art (e.g., text, graph). The resulting report shows a selected number of days (e.g., fifteen, thirty) of data for the selected device. In exemplary embodiments of the present invention, the graph is in bar chart format, each bar in the graph is a hyper link to the actual exceptions stored in the exception database table 400 for that particular day. If the user requests details for a particular day at 512, by double clicking on the bar, then the user is presented, at 514, with the exception detail for that day for that device. Processing then ends at 516.

In exemplary embodiments of the present invention, if the user selects trending by city at 508, then reports are pulled based on a particular city where the network device is located. The city may be selected from a pull down menu of all cities where network devices are located. Once the city is selected, the resulting report is presented to the user in any form known in the art (e.g., text, graph). The resulting report shows a selected number of days (e.g., fifteen, thirty) of data for the selected city. In exemplary embodiments of the present invention, the graph is in bar chart format, each bar in the graph is a hyper link to the actual exceptions stored in the exception database table 400 for that particular day. If the user requests details for a particular day at 512, by double clicking on the bar, then the user is presented, at 514, with the exception detail for that day for that city. Processing then ends at 516.

In exemplary embodiments of the present invention, if the user selects trending by category at 508, then reports are pulled based on a particular category of configuration (e.g., router IOS) and/or a particular device type within the category. The device type may be selected from a pull down menu of all configuration categories. An option to also select a particular device within the configuration category is presented to the user. Once the configuration category is selected, the resulting report is presented to the user in any form known in the art (e.g., text, graph). The resulting report shows a selected number of days (e.g., fifteen, thirty) of data for the selected configuration category. In exemplary embodiments of the present invention, the graph is in bar chart format, each bar in the graph is a hyper link to the actual exceptions stored in the exception database table 400 for that particular day. If the user requests details for a particular day at 512, by double clicking on the bar, then the user is presented, at 514, with the exception detail for that day for that configuration category. Processing then ends at 516.

In exemplary embodiments of the present invention, if the user selects trending by host 508, then reports are pulled based on a particular host as specified by a router name. Once the host is entered, the resulting report is presented to the user in any form known in the art (e.g., text, graph). The resulting report shows a selected number of days (e.g., fifteen, thirty) of data for the selected host. In exemplary embodiments of the present invention, the graph is in bar chart format, each bar in the graph is a hyper link to the actual exceptions stored in the exception database table 400 for that particular day. If the user requests details for a particular day at 512, by double clicking on the bar, then the user is presented, at 514, with the exception detail for that day for that host. Processing then ends at 516.

Exemplary embodiments of the present invention reduce the time required for verifying router configurations when compared to a manual process. This time-savings can be significant for networks that include thousands of network devices. In addition to the time savings, trends can be spotted and analysis performed based on the exception data. Exemplary embodiments of the present invention are not limited to routers and may be utilized to gather configuration data from any network device that is accessible by the host system 104.

As described above, embodiments can be embodied in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A method for auditing network device configurations, the method comprising:
gathering configuration data from at least one network device;
comparing the configuration data for the network device to a corresponding template;
generating exception data in response to the comparing; and
generating a report in response to receiving a reporting request from a user, wherein input to the report includes the exception data.

2. The method of claim 1 further comprising transmitting the report to the user.

3. The method of claim 1 wherein the gathering includes accessing the network device and querying the configuration file of the network device.

4. The method of claim 1 wherein the gathering, comparing and generating exception data are performed on a periodic basis.

5. The method of claim 4 wherein the periodic basis is every twenty four hours.

6. The method of claim 1 wherein the network device is a router.

7. The method of claim 1 wherein the network device is associated with a device type and the template corresponds to the network device based on the device type.

8. The method of claim 1 wherein the template includes one or more tables each corresponding to a parameter type.

9. The method of claim 8 wherein the parameter types include at least one of Internet protocol hosts, terminal access concentrator access control servers, and privileges.

10. The method of claim 1 wherein the exception data includes an exception date, an exception network device identifier, an exception category, an exception detail and an exception reason.

11. The method of claim 10 wherein the exception category includes one or more of Internet protocol hosts, terminal access concentrator access control servers and privileges.

12. The method of claim 10 wherein the exception reason includes one of remove, add and incorrect.

13. The method of claim 1 wherein the reporting request is for an ad-hoc report.

14. The method of claim 1 wherein the reporting request is for a standard report and the request includes a trending type.

15. The method of claim 14 wherein the trending type includes one of trending by device type, trending by city, trending by device category and trending by host.

16. The method of claim 15 further comprising:
receiving a request from the user to display the exception data for a selected day and trending type; and
transmitting the exception data for the selected day and trending type to the user.

17. A system for auditing network device configurations, the system comprising:
a host system and at least one network device, wherein the host system includes instructions to implement a method comprising:
gathering configuration data from the network device;
comparing the configuration data for the network device to a corresponding template;
generating exception data in response to the comparing; and
generating a report in response to receiving a reporting request from a user, wherein input to the report includes the exception data.

18. The system of claim 17 wherein the host system is in communication with the at least one network device via one or more networks.

19. The system of claim 18 wherein one of the networks is the Internet.

20. The system of claim 17 wherein the network device is a router.

21. The system of claim 17 further comprising a user system in communication with the host system, wherein the user generates the reporting request via the user system.

22. A computer program product for auditing network device configurations, the computer program product comprising:
a storage medium readable by a processing circuit and storing instructions for execution by the processing circuit for facilitating a method comprising:
gathering configuration data from at least one network device;
comparing the configuration data for the network device to a corresponding template;
generating exception data in response to the comparing; and
generating a report in response to receiving a reporting request from a user, wherein input to the report includes the exception data.

23. The computer program product of claim 22 wherein the gathering includes accessing the network device and querying the configuration file of the network device.

24. The computer program product of claim 22 wherein the gathering includes receiving a configuration file from the network device on a periodic basis.

25. The computer program product of claim 22 wherein the gathering includes receiving a configuration file from the network device in response to an update to the configuration file.
